(19) United States
(12) Patent Application Publication
(10) Pub. No.: US 2010/0223878 A1
(43) Pub. Date: Sep. 9, 2010

(54) Intumescent coating composition and process for fire-retardant wood product having intumescent coating

(76) Inventors: Craig Lipka, Cresskill, NJ (US); John Philosophos, Cicago, IL (US); Roger Youngs, Hinsdale, IL (US)

Correspondence Address: Royal W. Craig;Ober, Kaler, Grimes & Schriver, 120 East Baltimore Street, Baltimore, MD, 21202-1643, US

(21) Appl. No.: 12/460,219

(22) Filed: Jul. 15, 2009

Related U.S. Application Data
(60) Provisional application No. 61/209,317, filed on Mar. 5, 2009.

(51) Int. Cl. E04B 1/94; C09K 21/00; B05D 1/36; B32B 21/04

(52) U.S. Cl. 52/741.3; 252/606; 427/402; 428/447

(57) ABSTRACT

An intumescent coating composition, coating process for structural panels, and a method of installing the coated and notched structural panels that decreases the fire safety (FSR) rating effectively to meet applicable fire safety approval standards for commercial structures. The intumescent composition comprises sodium silicate, cenospheres, water, and sodium tetradecyl sulfate, and may further comprise either magnesium hydroxide, zinc borate, and amorphous silica, or mineral fibers. The intumescent composition may be applied to wood products, including lumber and any manufactured wood products such as wood structural panels (plywood, OSB, or composite panels), for protection against high temperatures and long periods of heat exposure. The coated panels are notched about their peripheral edges. During installation, the notched, coated panels are installed side-by-side to the framing so that the panels' notches form widened recessed seams, and the seams are then filled with a fire resistant caulk.

### CROSS-REFERENCE TO RELATED APPLICATION

The present application derives priority from U.S. Provisional Patent Application 61/209,317 filed on Mar. 5, 2009, which is incorporated herein by reference.

### BACKGROUND OF THE INVENTION

1. Field of the Invention

The present invention relates to an intumescent coating composition and fire-retardant wood products, and more specifically, to an intumescent ceramic coating composition having no volatile organic compounds and a process for applying the fire-retardant coating to a wood product for protection against high temperatures and long periods of heat exposure, and an installation method for the coated wood product.

2. Description of the Background

Wood and wood-based products are important components in the construction industry. In all types of buildings, wood products are commonly used in floor surfaces, walls, and ceilings. The wide-spread use of wood products can be attributed the wood products' appearance, acoustic qualities, and versatility. Two categories of wood products are lumber and manufactured wood products, such as wood structural panels.

Wood structural panels are manufactured from veneers, wood strands, wafers, or a combination thereof. The constituents are bonded together using water-proof synthetic resins or other suitable adhesive means. Common examples of wood structural panels include plywood, oriented strand board (OSB), and composite panels. Wood structural panels are commonly used for subfloors and underlayments, wall sheathing, and roof sheathing.

Portland Manufacturing Company first commercially produced plywood in 1907. Plywood comprises multiple layers of wood veneers—thin sheets of wood—that are adhesively bonded together under heat and pressure. Each veneer layer is oriented so that its grain is at right angles to the grain of adjacent layers. This cross-lamination provides for greater strength by distributing along-the-grain strength of wood in both directions.

OSB was introduced by the Elmendorf Manufacturing Company in 1982, and now dominates the national market for residential sheathing, accounting for 60% or more of the structural sheathing sold nationwide. OSB includes oriented strands of wood derived from naturally occurring hard or soft woods, cut into strands, wafers or particles, coated with a polymeric thermosetting binder resin and wax additive. Typically, the wax, resin and additives are sprayed upon the wood strands as the strands are tumbled in a drum blender. The blended mixture is formed into either a random mat or oriented multi-layered mats. The formed mats are pressed under a hot press machine that fuses and binds together the coated wood materials to form a consolidated OSB panel of desired thickness and size.

Uncoated wood structural panels or panels coated with latex paint are commonly used for room lining in residential occupancies because the flame spread rating (FSR) is less than the maximum permitted by the NBCC or the U.S. Model Codes. However, commercial structures are held to higher FSR standards, and so additional precautions must be taken with wood structural panels. Indeed, many building codes require a fire retardant barrier in the walls. Typical precautions include mixing fire retardant materials in with the constituents during the fabrication process, or painting panels with fire retardant latex paints. Both solutions are expensive and have limited efficacy. Another fire retardation method includes the use of intumescent substances.

Intumescent substances swell when exposed to heat, increasing in volume and decreasing in density. Owing to this property, it is well-known to employ intumescents for fire protection. Intumescent materials can expand from 10 to 20 times their original thickness when exposed to a fire. Conventional intumescent systems include an inorganic polymer-binder, a char or carbon skeleton forming substance (typically referred to as “carbonific”), an expanding agent (typically referred to as “spumific”), and an acid forming substance as essential components. Typical examples of such compositions can be found in U.S. Pat. Nos. 4,442,157, 4,638,538, and 3,562,197. And intumescent compositions can be applied by any conventional method, e.g., spraying, dipping, drawing, and brushing.

Unfortunately, carbon char-forming, intumescent compositions are not cost effective on wood products including wood structural panels (plywood, OSB, waferboard, etc.) LVL, particleboard, fiberboards, and the like, when trying to prevent a fire burn through versus a flame spread. Voids in the uncoated wood product's surfaces accelerate fire spread, and the seams between adjacent products also accelerate fire spread. These voids and seams provide low density areas that allow fire and air to pass more freely, and thus the panels are more likely to fail.

It would be greatly advantageous to provide a fire retardant, inorganic, and ceramic intumescent coating composition, which can be applied to any wood product for protection against high temperatures and long periods of heat exposure. These objectives are herein accomplished with a unique intumescent coating composition that can be applied to a wood product, including lumber and any manufactured wood products such as wood structural panels. These objectives are further accomplished with a manufacturing process that includes notching the peripheral edges of a wood structural panel and coating the panel's surfaces with the unique intumescent composition, and with a method of installing the notched, coated structural panels that includes caulking the notched seams between adjacent panels.

The intumescent coating composition and manufacturing process described herein decreases the FSR rating of the structural panels, compliant with FM Approval Standard Class Number 4975, ULC CAN4 S124-M, or UL 1715 (Room fire test). UBC 26-3, UBC 26-2, or ASTM E 84, are better-suited for commercial structures. Specifically, a structural panel coated with the intumescent coating composition using the process described herein passes all three separate tests of ASTM E 84—the flame spread, intermittent flame, and burning brand tests.

### SUMMARY OF THE INVENTION

These and other objects are accomplished herein by an intumescent coating composition; a manufacturing process for coating a wood structural panel with the intumescent composition; and a method of installing coated, notched wood structural panels.

The intumescent composition comprises sodium silicate, cenospheres, water, and sodium tetradecyl sulfate, and may further comprise either magnesium hydroxide, zinc borate, and amorphous silica, or mineral fibers. The intumescent composition may be applied to wood products, including lumber and any manufactured wood products such as wood structural panels (plywood, OSB, or composite panels), for protection against high temperatures and long periods of heat exposure.

In the process of manufacturing wood structural panels using the intumescent composition, a notch is machined about the peripheral edges of the panel. And in a unique coating process, an undercoat is applied to the panel, and then a topcoat is applied. During installation, the notched, coated panels are installed side-by-side to the framing so that the panels' notches form widened recessed seams. The recessed seams are then filled with a fire resistant caulk. Caulking the seams between the panels decreases the FSR rating of the wood structural panels, compliant with applicable standards for commercial structures.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a block diagram illustrating an embodiment for a process of manufacturing a fire-retardant wood structural panel.

FIG. 2 is a composite cross-section view showing a variety of exemplary notch configurations to be formed with a router, along with presently-preferred dimensions.

### DETAILED DESCRIPTION OF THE PREFERRED EMBODIMENTS

For protection against high temperatures and long periods of heat exposure, the present invention includes a unique intumescent coating composition that may be applied to any wood product, including lumber and manufactured wood products, such as wood structural panels. Using the intumescent composition, a fire-retardant wood structural panel may be manufactured by notching the panel's peripheral top edge and coating the panel with the intumescent coating composition using a double coat on one side and a single coat on the other. For further fire protection, the notched, coated panels are installed side-by-side and the recessed seams formed by adjacent panels are filled with a fire-resistant caulk.

In an embodiment, the intumescent composition comprises sodium silicate, cenospheres, water, and sodium tetradecyl. In another embodiment, the intumescent composition further comprises either magnesium hydroxide, amorphous silica, and zinc borate, or mineral fibers.

Sodium silicate is the common name for the compound sodium metasilicate, Na₂SiO₃, formed by reacting sodium carbonate and silicon dioxide to form sodium silicate and carbon dioxide: Na₂CO₃+SiO₂→Na₂SiO₃+CO₂. It is readily commercially available in aqueous solution and in solid form. The sodium silicate acts as a binder in the coating, which promotes swelling when exposed to flame to form an insulating fire-retardant barrier.

The cenospheres are commercially available ceramic micro-balloons that are lightweight, strong microspheres formed of a ceramic composition composed primarily of aluminum silicates, magnesium silicates, sodium silicates, or mixtures of these materials. The cenospheres are preferably of 65 mesh or less, hollow, with a porous ceramic shell, and are considerably stronger and more abrasion resistant than siliceous (glass) hollow microspheres. The ceramic microspheres are derived from the ash from industrial furnaces that burn powdered coal. Because they are a byproduct, they are considerably less expensive than commercially manufactured microballoons. Ceramic cenospheres are commercially available under the Q-Cell™ Grades 100, 110, 120, from the PQ Corporation, Valley Forge, Pa.; and Extendospheres™ XOL-200, CO, SO, SF-14, from PA Industries, Chattanooga, Tenn. The ceramic cenospheres serve as an inexpensive, lightweight filler and binder (their spherical shape lends cohesive strength to the composition), and their ceramic composition increases insulation and flame resistance. Acting as a filler material, the cenospheres effectively increase the volume of the coating mixture while decreasing the weight and cost per unit volume. The reduced density of the coating formulated with hollow spheres allows application to vertical surfaces without sagging or slumping, and it improves shrinkage and sandability.

Sodium tetradecyl sulfate is an anionic surfactant comprising a white, waxy solid. It is commercially available under the tradename Niaproof 4® from the Niacet Corporation from Niagara Falls, N.Y.

Magnesium hydroxide is a commercially-available mineral with an empirical formula of Mg(OH)₂, and can be formed by precipitating it with a metathesis reaction between magnesium salts and metal hydroxides. The magnesium hydroxide is a cross linking agent that reduces setting time, while also functioning as a filler and smoke suppressant.

The amorphous silica is conventional silica gel produced by the acidification of solutions of sodium silicate to produce a gelatinous precipitate that is then washed and then dehydrated to produce colorless microporous silica. This constituent is widely available from a variety of foreign suppliers. Amorphous silica functions as a filler that reduces the composition density. As an alternative to amorphous silica, equal amounts of amorphous calcium silicate or glycerin may be used.

Zinc borate is an inorganic compound commercially available in a white powder form. An exemplary formulation of zinc borate is 2ZnO.3B₂O₃.3.5H₂O such as that sold under the Firebrake ZB™ brand by U.S. Borax. As an alternative to zinc borate, equal amounts of aluminum oxide, ammonium orthophosphate, zinc oxide, antimony oxide, zinc metaphosphate, potassium metaphosphate, zirconium oxide, chromium oxide, maganese oxide, yttrium oxide, or potassium oxide may be used, or a combination of the foregoing. The zinc borate functions as a cross-linking agent as well as a fire retardant, smoke suppressant, and an after-glow suppressant.

Mineral fibers are synthetically produced long, thin filaments that are categorized by their minimal aspect ratios (length to diameter). Mineral fibers impart desired mechanical properties, such as strength, to the coating. Preferably, the fibers have a high aspect ratio, i.e. approximately in the range of 15:1 to 30:1, but have a length that will not effect the application of the coating using a curtain coater, i.e. within a range of from approximately 75 to 175 microns. Common examples include wollastinite, Lapinus™, and fiberglass.

The presently-preferred and acceptable composition of a first embodiment of the intumescent composition comprising sodium silicate, cenospheres, water, and sodium tetradecyl is indicated as follows:

| Preferred % by Weight | Acceptable Range |
|---|---|
| 62.1-65.9% sodium silicate | 55-70% |
| 30.1-31.9% cenospheres | 25-35% |
| 3.9-4.1% water | 2.5-7.5% |
| 1% sodium tetradecyl sulfate | 0.5-1.5% |

Most preferably, the weight percentages for sodium silicate, cenospheres, water, and sodium tetradecyl sulfate are 64%, 31%, 4%, and 1%, respectively.

The presently-preferred and acceptable composition of a second embodiment of the intumescent composition comprising magnesium hydroxide, amorphous silica, and zinc borate is indicated as follows:

| Preferred % by Weight | Acceptable Range |
|---|---|
| 55.3-58.7% sodium silicate | 45-65% |
| 26.2-27.8% cenospheres | 20-35% |
| 7.3-7.7% magnesium hydroxide | 5-10% |
| 5.8-6.2% water | 2.5-10% |
| 1% sodium tetradecyl sulfate | 0.5-1.5% |
| 1% amorphous silica | 0.5-1.5% |
| 0.5% zinc borate | 0.25-1% |

Most preferably, the weight percentages for sodium silicate, cenospheres, magnesium hydroxide, water, sodium tetradecyl sulfate, amorphous silica, and zinc borate are 57%, 27%, 7.5%, 6%, 1%, 1%, and 0.5%, respectively.

The presently-preferred and acceptable composition of a third embodiment of the intumescent composition comprising mineral fibers is indicated as follows:

| Preferred % by Weight | Acceptable Range |
|---|---|
| 63.3-67.3% sodium silicate | 55-75% |
| 26.7-28.3% cenospheres | 20-35% |
| 4.0-4.2% water | 2-10% |
| 1.0% sodium tetradecyl sulfate | 0.5-1.5% |
| 1.9-2.1 mineral fibers | 0-5.0% |

Most preferably, the weight percentages for sodium silicate, cenospheres, water, sodium tetradecyl sulfate, and mineral fibers are 65.3%, 27.5%, 4.1%, 1%, and 2%, respectively.

Preparation of the intumescent composition according to any of the above-described embodiments entails combining the ingredients and mixing gently to avoid damage to the cenospheres.

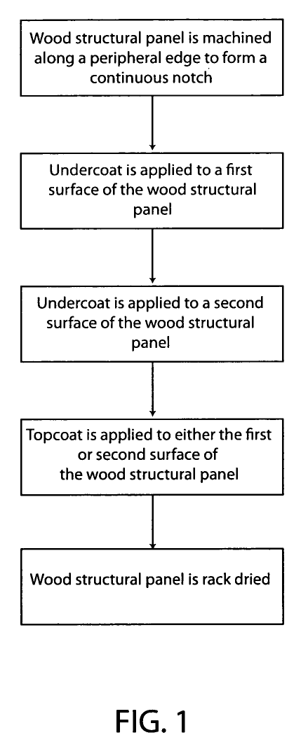

FIG. 1 is a block diagram illustrating an embodiment of a method for producing a fire-retardant wood structural panel. The method for producing a fire-retardant wood structural panel using the intumescent composition (any embodiment described above) generally comprises two primary steps: (1) notching peripheral edges of a manufactured wood structural panel, and (2) coating each panel with the intumescent composition. In an embodiment, the notching step entails machining each panel to define a notch about the peripheral edges of a panel's surface. The coating process includes applying three separate coats of the intumescent composition—an undercoat on a first surface, the undercoat on a second surface that is opposite the first surface, and a topcoat on either the first or second surface.

At step 10, a raw (unfinished) wood structural panel is machined along all four peripheral edges to form a notch on one surface of the panel. In an embodiment, the notch is on the surface that would be exposed to the fire. For example, using OSB, the notch would be machined on the rough side of the panel as this side is generally placed facing up on roofs or facing outward on exterior walls. The machining may take place with any conventional router.

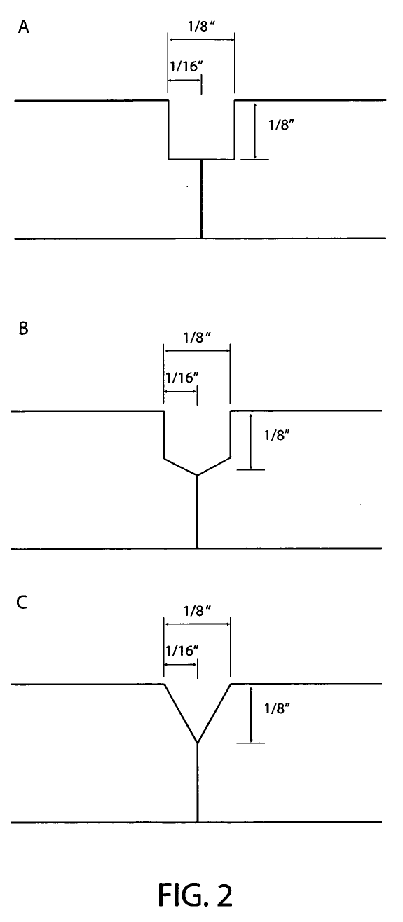

FIG. 2 is a composite cross-section showing a variety of exemplary notch configurations to be formed with the router, along with presently-preferred dimensions. FIG. 2(A) shows a rabbet notch configuration (of two boards side-by-side), which is an orthogonal recess that is machined into the peripheral edge of the wood structural panel. In an embodiment, the depth of the rabbet notch is ⅛″ and the width is 1/16″, so that the width of the seam formed by adjacent notched panels is ⅛″. In another embodiment, the notch is cut about all four peripheral edges of the panel's surface. FIG. 2(B) shows a notch embodiment in which the peripheral edges are machined to define a notch having a non-orthogonal angle. FIG. 2(C) shows a single-sided chamfer notch embodiment along the top peripheral edge. This notch embodiment is likewise non-orthogonal. The notches define a recessed seam when installed side-by-side with other panels of similar construction. The recessed seam is caulked, as described below, to seal all intermediate seams.

The coating step of the manufacturing process comprises the application multiple coats of an intumescent composition to a wood structural panel and then drying as seen in steps 20-50. To form the intumescent composition coatings, the foregoing ingredients are combined as shown above and mixed into a homogenous liquid suspension. The coatings may then be applied manually or, preferably, by using a curtain coater. Using a curtain coater, a wood structural panel is placed on a conveyor with the surface to be coated face up. The panel moves at a controlled speed along the conveyor under a continuous falling curtain of the coating, thereby receiving the coating on surface facing up. A variety of commercially available curtain coaters may be used, such as the Sorbini™ TM95 1E/F1 curtain coater.

At step 20, the undercoat coat is applied to a first surface of the panel. Preferably, the undercoat is the first embodiment of the intumescent composition—sodium silicate, cenospheres, water, and sodium tetradecyl sulfate. Assuming a standard size 2440 mm×1220 mm (8′×4′) wood structural panel, in an embodiment, 25-50 grams of the undercoat are uniformly applied to the first surface. Preferably, no more than 35 grams and no less than 25 grams are applied to the first surface. The first undercoat is then dried in ambient temperature until hard to the touch.

At step 30, an undercoat is applied to a second surface of the panel that is opposite the first surface. In an embodiment, the second undercoat uses the same formula as the first undercoat—the first embodiment (sodium silicate, cenospheres, water, and sodium tetradecyl sulfate). The panel coated with the first undercoat is turned over so that the second surface is facing up, and is passed through the curtain coater to impart an undercoat on the second surface. Like the first undercoat, 25-50 grams of undercoat are uniformly applied to the second surface. Preferably, no more than 35 grams and no less than 25 grams are applied to the second surface. The second undercoat is then dried in ambient temperature until hard to the touch.

The first and second undercoat (collectively, the undercoat) fills voids and cracks on the panel's surfaces. Thus, the undercoat eliminates wood strands that are raised from the surface, which prevents the surface from igniting before reaching the ignition temperature of wood—51 2° F. Additionally, the undercoat acts as a thermal barrier for the panel. Furthermore, when exposed to heat, the undercoat releases water at certain temperatures, which has a cooling effect. And as the temperature continues to rise, the released water turns into steam that pushes the topcoat, described below, off the panel's surface, improving fire retardation.

Next, at step 40, the third coat—a topcoat—is applied to either the first surface or the second surface by placing the undercoated panel through the curtain coater with the desired surface facing up. In an embodiment, the topcoat is the second embodiment of the intumescent composition—sodium silicate, cenospheres, magnesium hydroxide, water, amorphous silica, sodium tetradecyl sulfate, and zinc borate. In another embodiment, the topcoat is the third embodiment of the intumescent composition—sodium silicate, cenospheres, water, sodium tetradecyl sulfate, and mineral fibers. The topcoat is thicker than the previously applied undercoat as 200-300 grams are applied to the desired surface of a standard size panel. Preferably, no more than 234 grams and no less than 200 grams are applied to this surface.

In an embodiment, the surface coated with both the undercoat and the topcoat is the surface that will likely be exposed to the fire when installed. For example, the side of the panel that faces up in roofing installations and outward in exterior wall installation. When using OSB, this surface is generally the rough side. And because OSB comes from the supplier stacked with the smooth side up, the smooth side is coated first with the undercoat—the OSB panel is fed into the skim coater in the same orientation as it was stacked by the supplier. After the undercoat is applied to the smooth side, the OSB panel is flipped and coated with both the undercoat and then the topcoat.

At step 50, the coated wood structural panel (with both undercoats and a topcoat) is then rack dried. Because of the coatings' chemical compositions, the panels must be stored at a temperature greater than 60 degrees Fahrenheit and at a relative humidity range of 25 to 35% for a period of 24 hours.

Although the notching step 10 is discussed and illustrated before coating, steps 20-50 in FIG. 1, notching may occur after coating.

The installation method includes installing the notched, coated panels to the framing and then caulking the seams formed between adjacent installed panels. After manufacturing, the notched, coated wood structural panels are installed as desired side-by-side to a building frame using the appropriate fasteners such as nails or screws. The side-by-side installation forms a widened recessed seam between the installed panels, and this seam is then filled with any fire retardant caulk to fully fill the void. Filling the voids eliminates low density areas that allow fire and air to pass and, in combination with the elimination of surface voids, greatly improves the fire retardant capabilities of the finished installation. The caulk may be applied, for example, by using a mechanical or pneumatic caulk gun. Caulking the seams decreases the FSR rating of the wood structural panels, compliant with applicable standards for commercial structures. Optionally, the panel installer may then paint over the top coat on the first surface.

It should now be apparent that the above-described fire retardant intumescent coating composition, manufacturing process that includes notching the peripheral edges of a wood structural panel and coating the panel's surfaces with the intumescent composition, and method of installing the notched, coated structural panels with caulking the notched seams between adjacent panels, combine to decreases the FSR rating and all applicable approval standards for commercial structures.

Having now fully set forth the preferred embodiments and certain modifications of the concept underlying the present invention, various other embodiments as well as certain variations and modifications thereto may obviously occur to those skilled in the art upon becoming familiar with the underlying concept. For example, the sequence of steps may be altered such that the coating steps precede the notching of wood structural panel. It is to be understood, therefore, that the invention may be practiced otherwise than as specifically set forth herein.

We claim:

1. An intumescent coating composition, comprising:
sodium silicate;
cenospheres;
sodium tetradecyl sulfate; and
water.

2. The intumescent coating composition according to claim 1, wherein the sodium silicate is 55-70% of the composition's total weight; the cenospheres are 25-35% of the composition's total weight; the water is 2.5-7.5% of the composition's total weight; and the sodium tetradecyl sulfate is 0.5-1.5% of the composition's total weight.

3. The intumescent coating composition according to claim 2, wherein the sodium silicate is 62.1-65.9% of the composition's total weight; the cenospheres are 30.1-31.9% of the composition's total weight; the water is 3.9-4.1% of the composition's total weight; and the sodium tetradecyl sulfate is 1% of the composition's total weight.

4. The intumescent coating composition according to claim 3, wherein the sodium silicate is 64% of the composition's total weight; the cenospheres are 31% of the composition's total weight; and the water is 4% of the composition's total weight.

5. The intumescent coating composition according to claim 1, further comprising magnesium hydroxide, amorphous silica, and zinc borate.

6. The intumescent coating composition according to claim 5, wherein the sodium silicate is 45-65% of the composition's total weight; the cenospheres are 20-35% of the composition's total weight; magnesium hydroxide is 5-10% of the composition's total weight; the water is 2.5-10% of the composition's total weight; the sodium tetradecyl sulfate is 0.5-1.5% of the composition's total weight; the amorphous silica is 0.5-1.5% of the composition's total weight; and the zinc borate is 0.25-1.0% of the composition's total weight.

7. The intumescent coating composition according to claim 6, wherein the sodium silicate is 55.3-58.7% of the composition's total weight; the cenospheres are 26.2-27.8% of the composition's total weight; magnesium hydroxide is 7.3-7.7% of the composition's total weight; the water is 5.8-6.2% of the composition's total weight; the sodium tetradecyl sulfate is 1% of the composition's total weight; the amorphous silica is 1% of the composition's total weight; and the zinc borate is 0.5% of the composition's total weight.

8. The intumescent coating composition according to claim 7, wherein the sodium silicate is 57% of the composition's total weight; the cenospheres are 27% of the composition's total weight; magnesium hydroxide is 7.5% of the composition's total weight; and the water is 6% of the composition's total weight.

9. The intumescent coating composition according to claim 1, further comprising mineral fibers.

10. The intumescent composition according to claim 9, wherein the sodium silicate is 55-75% of the composition's total weight; the cenospheres are 20-35% of the composition's total weight; the water is 2.0-10% of the composition's total weight; the sodium tetradecyl sulfate is 0.5-1.5% of the composition's total weight; and the mineral fibers are 0-5% the composition's total weight.

11. The intumescent composition according to claim 10, wherein the sodium silicate is 63.3-67.3% of the composition's total weight; the cenospheres are 26.7-28.3% of the composition's total weight; the water is 4.0-4.2% of the composition's total weight; the sodium tetradecyl sulfate is 1% of the composition's total weight; and the mineral fibers are 1.9-2.1% the composition's total weight.

12. The intumescent composition according to claim 11, wherein the sodium silicate is 65.3% of the composition's total weight; the cenospheres are 27.5% of the composition's total weight; the water is 4.1% of the composition's total weight; and the mineral fibers are 2% of the composition's total weight.

13. A process for manufacturing a fire-retardant wood structural panel, comprising the steps of:
applying an undercoat of an intumescent composition to a first surface of the wood structural panel;
applying the undercoat of an intumescent composition to a second surface of the wood structural panel, the second surface being opposite the first surface; and
applying a topcoat of an intumescent composition to either the first surface or the second surface of the wood structural panel, the topcoat is applied on top of the undercoat.

14. The process for manufacturing a fire-retardant wood structural panel according to claim 13, wherein the undercoat applied to the first and second surfaces comprises sodium silicate, cenospheres, sodium tetradecyl sulfate, and water.

15. The process for manufacturing a fire-retardant wood structural panel according to claim 14, wherein the sodium silicate is 55-70% of the undercoat's total weight; the cenospheres are 25-35% of the undercoat's total weight; the water is 2.5-7.5% of the undercoat's total weight; and the sodium tetradecyl sulfate is 0.5-1.5% of the undercoat's total weight.

16. The process for manufacturing a fire-retardant wood structural panel according to claim 15, wherein the sodium silicate is 62.1-65.9% of the undercoat's total weight; the cenospheres are 30.1-31.9% of the undercoat's total weight; the water is 3.9-4.1% of the undercoat's total weight; and the sodium tetradecyl sulfate is 1% of the undercoat's total weight.

17. The process for manufacturing a fire-retardant wood structural panel according to claim 16, wherein the sodium silicate is 64% of the undercoat's total weight; the cenospheres are 31% of the undercoat's total weight; and the water is 4% of the undercoat's total weight.

18. The process for manufacturing a fire-retardant wood structural panel according to claim 13, wherein the topcoat comprises sodium silicate, cenospheres, magnesium hydroxide, water, sodium tetradecyl sulfate, amorphous silica, and zinc borate.

19. The process for manufacturing a fire-retardant wood structural panel according to claim 18, wherein the sodium silicate is 45-65% of the topcoat's total weight; the cenospheres are 20-35% of the topcoat's total weight; magnesium hydroxide is 5-10% of the topcoat's total weight; the water is 2.5-10% of the topcoat's total weight; the sodium tetradecyl sulfate is 0.5-1.5% of the topcoat's total weight; the amorphous silica is 0.5-1.5% of the topcoat's total weight; and the zinc borate is 0.25-1.0% of the topcoat's total weight.

20. The process for manufacturing a fire-retardant wood structural panel according to claim 19, wherein the sodium silicate is 55.3-58.7% of the topcoat's total weight; the cenospheres are 26.2-27.8% of the topcoat's total weight; magnesium hydroxide is 7.3-7.7% of the topcoat's total weight; water is 5.8-6.2% of the topcoat's total weight; sodium tetradecyl sulfate is 1% of the topcoat's total weight; amorphous silica is 1% of the topcoat's total weight; and zinc borate is 0.5% of the topcoat's total weight.

21. The process for manufacturing a fire-retardant wood structural panel according to claim 20, wherein sodium silicate is 57% of the topcoat's total weight; cenospheres are 27% of the topcoat's total weight; magnesium hydroxide is 7.5% of the topcoat's total weight; and water is 6% of the topcoat's total weight.

22. The process for manufacturing a fire-retardant wood structural panel according to claim 13, wherein the topcoat comprises sodium silicate, cenospheres, water, sodium tetradecyl sulfate, and mineral fibers.

23. The process for manufacturing a fire-retardant wood structural panel according to claim 22, wherein the sodium silicate is 55-75% of the topcoat's total weight; cenospheres are 20-35% of the topcoat's total weight; water is 2-10% the topcoat's total weight; sodium tetradecyl sulfate is 0.5-1.5% of the topcoat's total weight; and mineral fibers are 0-5% of the topcoat's total weight.

24. The process for manufacturing a fire-retardant wood structural panel according to claim 23, wherein sodium silicate is 63.3-67.3% of the topcoat's total weight; cenospheres are 26.7-28.3% of the topcoat's total weight; water is 4.0-4.2% of the topcoat's total weight; sodium tetradecyl sulfate is 1% of the topcoat's total weight; and mineral fibers are 1.9-2.1% of the topcoat's total weight.

25. The process for manufacturing a fire-retardant wood structural panel according to claim 24, wherein sodium silicate is 65.3% of the topcoat's total weight; cenospheres are 27.5% of the topcoat's total weight; water is 4.1% of the topcoat's total weight; and mineral fibers are 2% of the topcoat's total weight.

26. The process for manufacturing a fire-retardant wood structural panel according to claim 13, further comprising the step of notching a panel's peripheral edge.

27. The process for manufacturing a fire-retardant wood structural panel according to claim 26, wherein the step of notching a panel's peripheral edge includes notching all four peripheral edges of the panel.

28. The process for manufacturing a wood structural panel according to claim 26, wherein the notch formed by notching a panel's peripheral edge is a rabbet or chamfer notch.

29. A fire-retardant wood product, comprising a first surface coated with an undercoat of an intumescent composition and coated with a topcoat of an intumescent composition on top of the undercoat.

30. The fire-retardant wood product according to claim 29, wherein the undercoat comprises sodium silicate, cenospheres, sodium tetradecyl sulfate, and water.

31. The fire-retardant wood product according to claim 30, wherein sodium silicate is 55-70% of the undercoat's total weight; cenospheres are 25-35% of the undercoat's total weight; water is 0.5-1.5% of the undercoat's total weight; and sodium tetradecyl sulfate is 2.5-7.5% of the undercoat's total weight.

32. The fire-retardant wood product according to claim 31, wherein sodium silicate is 62.1-65.9% of the undercoat's total weight; cenospheres are 30.1-31.9% of the undercoat's total weight; water is 3.9-4.1% of the undercoat's total weight; and sodium tetradecyl sulfate is 1% of the undercoat's total weight.

33. The fire-retardant wood product according to claim 32, wherein sodium silicate is 64% of the undercoat's total weight; cenospheres are 31% of the undercoat's total weight; and water is 4% of the undercoat's total weight.

34. The fire-retardant wood product according to claim 30, wherein the topcoat comprises sodium silicate, cenospheres, magnesium hydroxide, water, sodium tetradecyl sulfate, amorphous silica, and zinc borate.

35. The fire-retardant wood product according to claim 34, wherein sodium silicate is 45-65% of the topcoat's total weight; cenospheres are 20-35% of the topcoat's total weight; magnesium hydroxide is 5-10% of the topcoat's total weight; water is 2.5-10% of the topcoat's total weight; sodium tetradecyl sulfate is 0.5-1.5% of the topcoat's total weight; amorphous silica is 0.5-1.5% of the topcoat's total weight; and zinc borate is 0.25-1.0% of the topcoat's total weight.

36. The fire-retardant wood product according to claim 35, wherein sodium silicate is 55.3-58.7% of the topcoat's total weight; cenospheres are 26.2-27.8% of the topcoat's total weight; magnesium hydroxide is 7.3-7.7% of the topcoat's total weight; water is 5.8-6.2% of the topcoat's total weight; sodium tetradecyl sulfate is 1% of the topcoat's total weight; amorphous silica is 1% of the topcoat's total weight; and zinc borate is 0.5% of the topcoat's total weight.

37. The fire-retardant wood product according to claim 36, wherein sodium silicate is 57% of the topcoat's total weight; cenospheres are 27% of the topcoat's total weight; magnesium hydroxide is 7.5% of the topcoat's total weight; and water is 6% of the topcoat's total weight.

38. The fire-retardant wood product according to claim 30, wherein the topcoat comprises sodium silicate, cenospheres, water, sodium tetradecyl sulfate, and mineral fibers.

39. The fire-retardant wood product according to claim 38, wherein sodium silicate is 55-75% of the topcoat's total weight; cenospheres are 20-35% of the topcoat's total weight; water is 2-10% the topcoat's total weight; sodium tetradecyl sulfate is 0.5-1.5% the topcoat's total weight; and mineral fibers are 0-5% the topcoat's total weight.

40. The fire-retardant wood product according to claim 39, wherein sodium silicate is 63.3-67.3% of the topcoat's total weight; cenospheres are 26.7-28.3% of the topcoat's total weight; water is 4.0-42% of the topcoat's total weight; sodium tetradecyl sulfate is 1% of the topcoat's total weight; and mineral fibers are 1.9-2.1% the topcoat's total weight.

41. The fire-retardant wood product according to claim 40, wherein sodium silicate is 65.3% of the topcoat's total weight; cenospheres are 27.5% of the topcoat's total weight; water is 4.1% the topcoat's total weight; and mineral fibers are 2% the topcoat's total weight.

42. The fire-retardant wood product according to claim 34, wherein the wood product is a wood structural panel further comprising a second surface, opposite the first surface, coated with the undercoat.

43. The fire-retardant wood product according to claim 42, wherein the wood structural panel further comprises a notch about all four peripheral edges of the first surface.

44. The fire-retardant wood product according to claim 38, wherein the wood product is a wood structural panel further comprising a second surface, opposite the first surface, coated with the undercoat.

45. The fire-retardant wood product according to claim 44, wherein the wood structural panel further comprises a notch about all four peripheral edges of the first surface.

46. A process for installing a plurality of fire-retardant wood structural panels, comprising the steps of:
providing wood structural panels having
a first surface coated with an undercoat of an intumescent composition and a topcoat of an intumescent composition,
a second surface, opposite the first surface, coated with the undercoat of an intumescent composition, and
a notch along the panels' peripheral edges;
affixing the wood structural panels side-by-side to a frame; and
caulking the recessed seams formed by adjacent notches in the side-by-side affixed sheets with a fire-retardant caulk.

47. A process for installing a plurality of fire-retardant wood structural panels according to claim 46, wherein the undercoat comprises sodium silicate, cenospheres, sodium tetradecyl sulfate, and water; and the topcoat comprises sodium silicate, cenospheres, magnesium hydroxide, water, sodium tetradecyl sulfate, amorphous silica, and zinc borate.

48. A process for installing a plurality of fire-retardant wood structural panels according to claim 46, wherein the undercoat comprises sodium silicate, cenospheres, sodium tetradecyl sulfate, and water; and the topcoat comprises sodium silicate, cenospheres, water, sodium tetradecyl sulfate, and mineral fibers.
